(19) United States
(12) Patent Application Publication
(10) Pub. No.: US 2011/0102333 A1
(43) Pub. Date: May 5, 2011

(54) Detection of Gesture Orientation on Repositionable Touch Surface

(76) Inventor: Wayne Carl WESTERMAN, San Francisco, CA (US)

(21) Appl. No.: 12/609,982

(22) Filed: Oct. 30, 2009

(51) Int. Cl. G06F 3/041

(52) U.S. Cl. 345/173

(57) ABSTRACT

Detection of an orientation of a gesture made on a repositionable touch surface is disclosed. In some embodiments, a method can include detecting an orientation of a gesture made a touch surface of a touch sensitive device and determining whether the touch surface has been repositioned based on the detected gesture orientation. In other embodiments, a method can include setting a window around touch locations captured in a touch image of a gesture made on a touch surface of a touch sensitive device, detecting an orientation of the gesture in the window, and determining whether the touch surface has been repositioned based on the detected gesture orientation. The pixel coordinates of the touch surface can be changed to correspond to the repositioning.

### FIELD

This relates generally to touch surfaces and, more particularly, to detecting an orientation of a gesture made on a touch surface indicative of a repositioning of the touch surface.

### BACKGROUND

Many types of input devices are presently available for performing operations in a computing system, such as buttons or keys, mice, trackballs, joysticks, touch sensor panels, touch screens and the like. Touch sensitive devices, such as touch screens, in particular, are becoming increasingly popular because of their ease and versatility of operation as well as their declining price. A touch sensitive device can include a touch sensor panel, which can be a clear panel with a touch-sensitive surface, and a display device such as a liquid crystal display (LCD) that can be positioned partially or fully behind the panel so that the touch-sensitive surface can cover at least a portion of the viewable area of the display device. The touch sensitive device can allow a user to perform various functions by touching the touch-sensitive surface of the touch sensor panel using a finger, stylus or other object at a location often dictated by a user interface (UI) being displayed by the display device. In general, the touch sensitive device can recognize a touch event and the position of the touch event on the touch sensor panel, and the computing system can then interpret the touch event in accordance with the display appearing at the time of the touch event, and thereafter can perform one or more actions based on the touch event.

The computing system can map a coordinate system to the touch-sensitive surface of the touch sensor panel to help recognize the position of the touch event. Because touch sensitive devices can be mobile and the orientation of touch sensor panels within the devices can be changed, inconsistencies can appear in the coordinate system when there is movement and/or orientation change, thereby adversely affecting position recognition and subsequent device performance.

### SUMMARY

This relates to detecting an orientation of a gesture made on a touch surface to determine whether the touch surface has been repositioned. To do so, an orientation of a gesture made on a touch surface of a touch sensitive device can be detected and a determination can be made as to whether the touch surface has been repositioned based on the detected gesture orientation. In addition or alternatively, a window can be set around touch locations captured in a touch image of a gesture made on a touch surface of a touch sensitive device, an orientation of the gesture in the window can be detected, and a determination can be made at to whether the touch surface has been repositioned based on the detected gesture orientation. The ability to determine whether a touch surface has been repositioned can advantageously provide accurate touch locations regardless of device movement. Additionally, the device can robustly perform in different positions.

### BRIEF DESCRIPTION OF THE DRAWINGS

FIG. 1 illustrates an exemplary touch surface according to various embodiments.

FIG. 2 illustrates an exemplary touch surface having a gesture made thereon according to various embodiments.

FIGS. 3a through 3i illustrate exemplary touch locations for gestures made on a touch surface according to various embodiments.

FIG. 4 illustrates an exemplary method of detecting an orientation of a gesture made on a touch surface to determine a 180° repositioning of the touch surface according to various embodiments.

FIGS. 5a and 5b illustrate exemplary vectors between touch locations for gestures made on a touch surface that can be utilized to determine a repositioning of the touch surface according to various embodiments.

FIGS. 6a through 6d illustrate exemplary vectors between touch locations for ambiguous gestures made on a touch surface to determine a repositioning of the touch surface according to various embodiments.

FIG. 7 illustrates an exemplary method of detecting an orientation of a gesture made on a touch surface to determine a 90° repositioning of the touch surface according to various embodiments.

FIG. 8 illustrates an exemplary window around touch locations for gestures made on a touch surface that can be utilized to determine a repositioning of the touch surface according to various embodiments.

FIG. 9 illustrates an exemplary computing system that can detect an orientation of a gesture made on a touch surface to determine a repositioning of the touch surface according to various embodiments.

### DETAILED DESCRIPTION

In the following description of various embodiments, reference is made to the accompanying drawings which form a part hereof, and in which it is shown by way of illustration specific embodiments which can be practiced. It is to be understood that other embodiments can be used and structural changes can be made without departing from the scope of the various embodiments.

This relates to detecting an orientation of a gesture made on a touch surface to determine whether the touch surface has been repositioned. In some embodiments, a method can include detecting an orientation of a gesture made a touch surface of a touch sensitive device and determining whether the touch surface has been repositioned based on the detected gesture orientation. In other embodiments, a method can include setting a window around touch locations captured in a touch image of a gesture made on a touch surface of a touch sensitive device, detecting an orientation of the gesture in the window, and determining whether the touch surface has been repositioned based on the detected gesture orientation.

The ability to determine whether a touch surface of a touch sensitive device has been repositioned can advantageously provide accurate touch locations regardless of the device's movement. Additionally, the device can robustly perform in different positions.

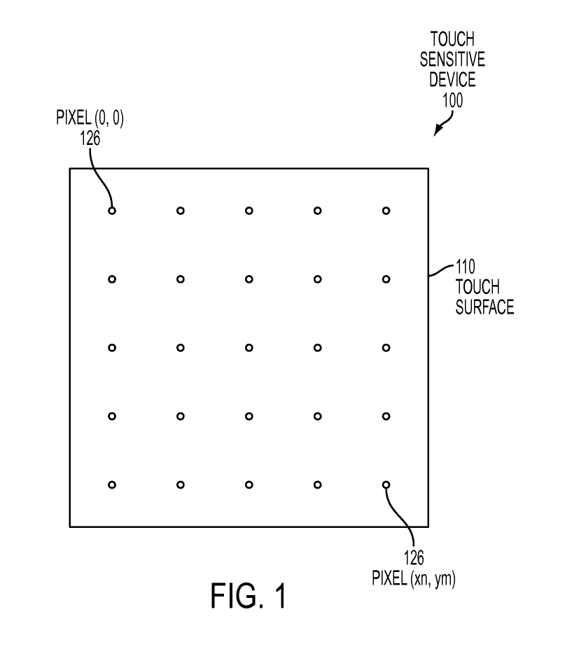

FIG. 1 illustrates an exemplary repositionable touch surface according to various embodiments. In the example of FIG. 1, touch surface 110 of touch sensitive device 100 can have coordinate pairs that correspond to locations of touch pixels 126. It should be noted that touch pixels 126 can represent distinct touch sensors at each touch pixel location (e.g., discrete capacitive, resistive, force, optical, or the like sensors), or can represent locations in the touch surface at which touches can be detected (e.g., using surface acoustic wave, beam-break, camera, resistive, or capacitive plate, or the like sensing technologies). In this example, the pixel 126 in the upper left corner of the touch surface 110 can have coordinates (0, 0) and the pixel in the lower right corner of the touch surface can have coordinates (xn, ym), where n, m can be the numbers of rows and columns, respectively, of pixels. The touch surface 110 can be repositionable. For example, the touch surface 110 can be repositioned by +90° such that the pixel 126 in the upper left corner is repositioned to the upper right corner. The touch surface 110 can be repositioned by 180° such that the pixel 126 in the upper left corner is repositioned to the lower right corner. The touch surface 110 can be repositioned by −90° such that the pixel 126 in the upper left corner is repositioned to the lower left corner. Other repositioning is also possible depending on the needs and comfort of the user with respect to the executing application and to the device.

For simplicity, the pixel 126 in the upper left corner of the touch surface (regardless of repositioning) can always be assigned the coordinate pair (0, 0) and the pixel in the lower right corner can always be assigned the coordinate pair (xn, ym). As such, when the touch surface 110 is repositioned, the pixels' original coordinate pairs no longer apply and should be changed to correspond to the pixels' new positions in the repositioned touch surface 110. For example, when the touch surface 110 repositions by +90°, resulting in the pixel 126 in the upper left corner moving to the upper right corner, the pixel's coordinate pair (0, 0) can be changed to (0, ym). Similarly, when the touch surface 110 repositions by 180°, resulting in the pixel 126 in the upper left corner moving to the lower right corner, the pixel's coordinate pair (0, 0) can be changed to (xn, ym). To determine how to change the coordinate pairs, a determination can first be made of how the touch surface has been repositioned. According to various embodiments, this determination can be based on an orientation of a gesture made on the touch surface, as will be described below.

Although the touch surface is illustrated as having Cartesian coordinates, it is to be understood that other coordinates, e.g., polar coordinates, can also be used according to various embodiments.

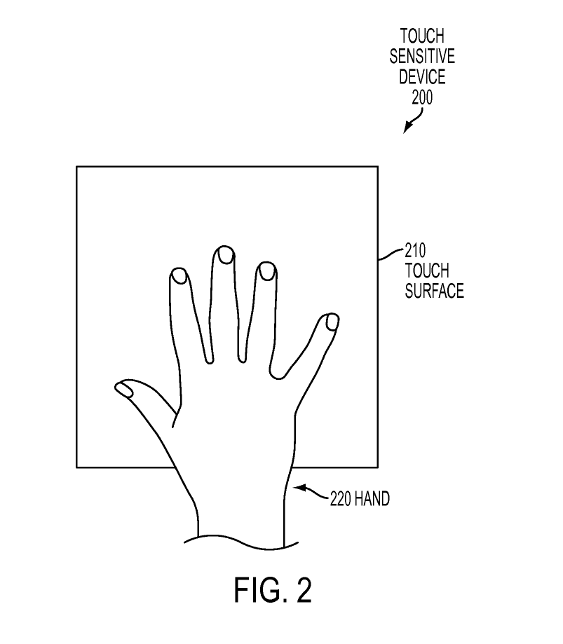

FIG. 2 illustrates an exemplary touch surface having a gesture made thereon according to various embodiments. In the example of FIG. 2, a user can make a gesture on touch surface 210 of touch sensitive device 200 in which fingers of the user's hand 220 are spread across the touch surface.

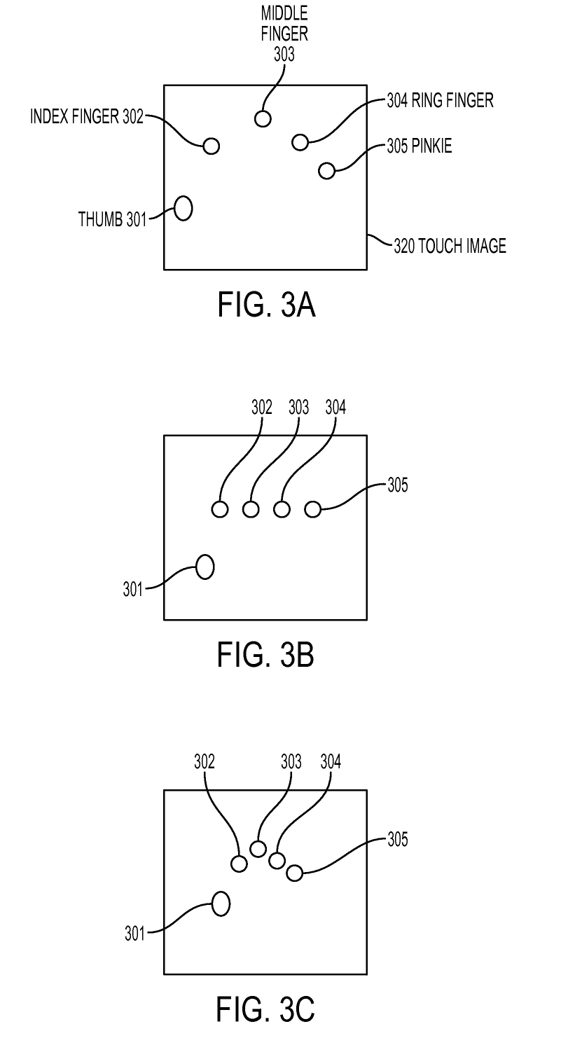

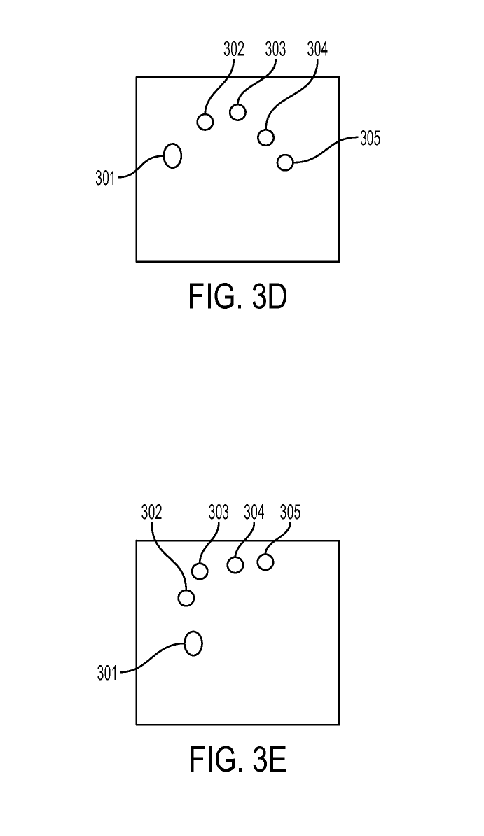

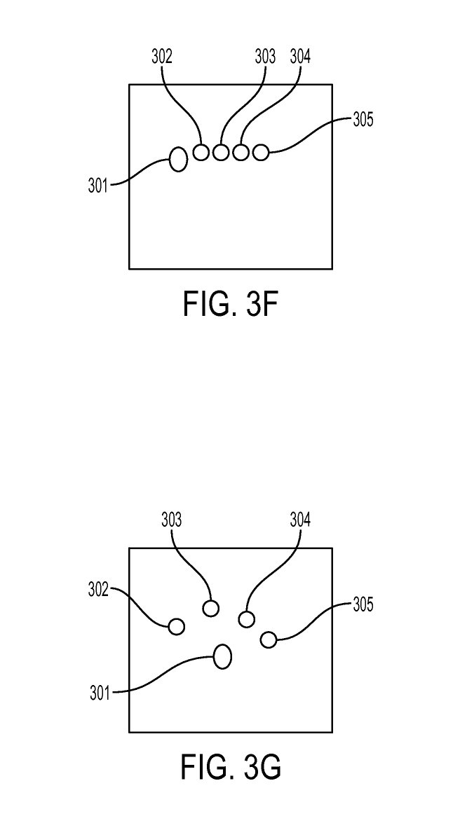

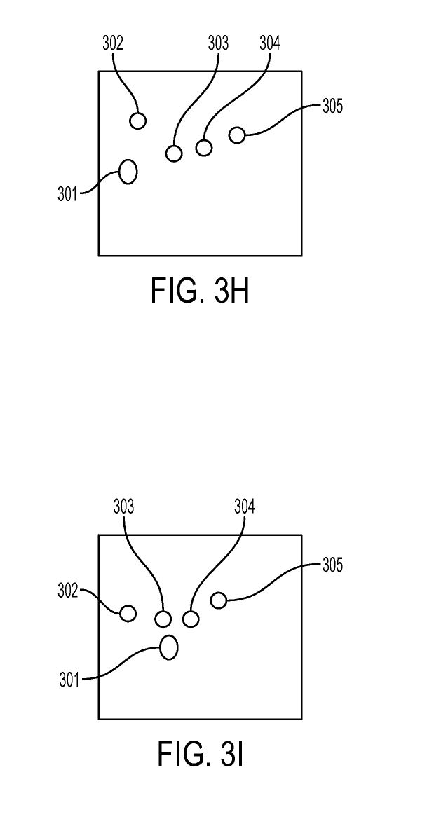

FIGS. 3a through 3i illustrate exemplary touch locations for gestures made on a touch surface according to various embodiments. The touch locations are illustrated in touch images capturing the gestures. FIG. 3a illustrates touch locations in a touch image of the hand gesture in FIG. 2. Here, touch locations 301 through 305 of thumb, index finger, middle finger, ring finger, and pinkie, respectively, are spread across touch image 320. FIG. 3b illustrates touch locations 301 through 305 of a hand gesture in which the touch locations of the four fingers are horizontally aligned. FIG. 3c illustrates touch locations 301 through 305 in which the thumb and four fingers are close together. FIG. 3d illustrates touch locations 301 through 305 in which the hand is rotated slightly to the right such that the thumb and pinkie touch locations are horizontally aligned. FIG. 3e illustrates touch locations 301 through 305 in which the hand is rotated to the left such that the fingers are nearer the top of the touch surface and the thumb is lower on the touch surface. FIG. 3f illustrates touch locations 301 through 305 in which all five touch locations are horizontally aligned. FIG. 3g illustrates touch locations 301 through 305 in which the thumb is tucked beneath the four fingers. FIG. 3h illustrates touch locations 301 through 305 in which the index finger and pinkie are extended and the middle and ring fingers are bent. FIG. 3i illustrates touch locations 301 through 305 similar to those of FIG. 3h except the thumb is tucked below the bent middle and ring fingers. Other touch locations are also possible. Orientation of the gestures can be determined from the touch locations in the touch images and utilized to determine whether the touch surface has been repositioned.

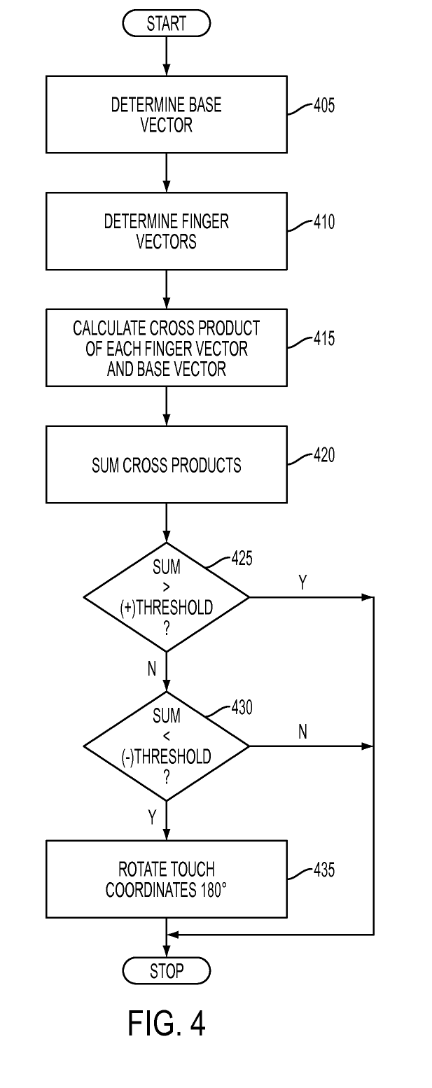

FIG. 4 illustrates an exemplary method of detecting an orientation of a gesture made on a touch surface to determine a 180° repositioning of the touch surface according to various embodiments. In the example of FIG. 4, a touch image of a gesture made on a touch surface can be captured and touch locations in the touch image identified. A base vector can be determined from the leftmost and rightmost touch locations on the touch surface (405). In some embodiments, the leftmost touch location can be designated as the base vector endpoint. In other embodiments, the rightmost touch location can be designated as the base vector endpoint. The base vector can be formed between the leftmost and rightmost touch locations using any known vector calculation techniques. In most cases, these touch locations correspond to thumb and pinkie touches. In those cases where they do not, additional logic can be executed, as will be described later. Finger vectors can be determined between the designated base vector endpoint and the remaining touch locations on the touch surface (410). For example, if the base vector endpoint corresponds to a thumb touch location and the other base vector point corresponds to a pinkie touch location, a first finger vector can be formed between the thumb and index finger touch locations; a second finger vector can be formed between the thumb and the middle finger touch locations; and a third finger vector can be formed between the thumb and the ring finger touch locations. The finger vectors can be formed using any known vector calculation techniques.

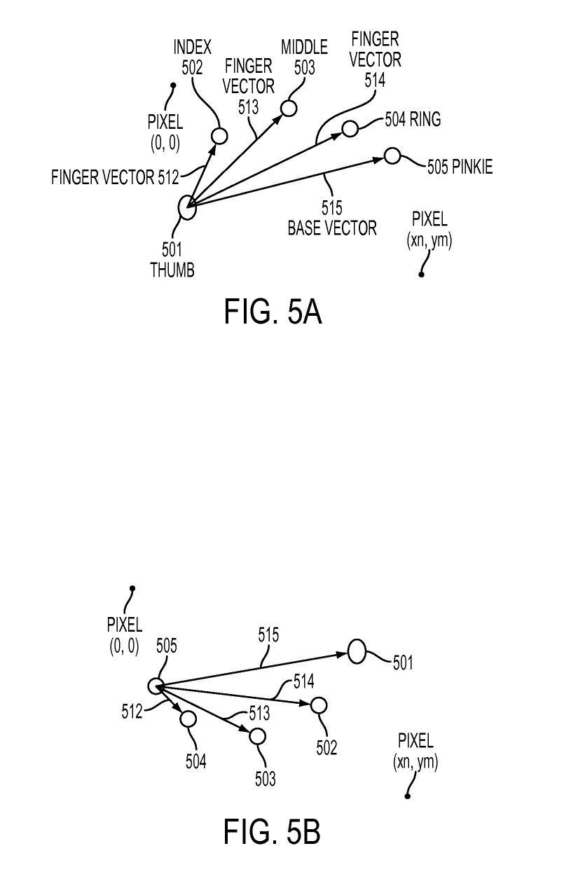

FIGS. 5a and 5b illustrate exemplary base and finger vectors between touch locations for gestures made on a touch surface that can be utilized to determine a repositioning of the touch surface according to various embodiments. The example of FIG. 5a illustrates base and finger vectors between the touch locations of FIG. 3a. Here, base vector 515 can be formed between the leftmost touch location (thumb location 501) and the rightmost touch location (pinkie location 505) with the leftmost location as the vector endpoint. Finger vector 512 can be formed between the leftmost touch location and the adjacent touch location (index finger location 502) with the leftmost touch location as the vector endpoint. Finger vector 513 can be formed between the leftmost touch location and the next touch location (middle finger location 503) with the leftmost touch location as the vector endpoint. Finger vector 514 can be formed between the leftmost touch location and the next touch location (ring finger location 504) with the leftmost touch location as the vector endpoint.

In the example of FIG. 5a, the touch surface has not been repositioned, such that the original pixel in the upper left corner of the touch image maintains coordinate pair (0, 0) and the original pixel in the lower right corner maintains coordinate pair (xn, ym). The touch locations 501 through 505 have a convex orientation. In this example, the gesture is made by a right hand. A similar left handed gesture has the touch locations reversed left to right with a similar convex orientation.

The example of FIG. 5b illustrates base and finger vectors between the touch locations of FIG. 3a when the touch surface has been repositioned by 180° but the pixel coordinates have not been changed accordingly. Therefore, relative to the pixel coordinate (0, 0), the touch locations can appear inverted in the touch image with a concave orientation. As such, the vectors can be directed downward. Base vector 515 can be formed between the leftmost touch location (pinkie location 505) and the rightmost touch location (thumb location 501) with the leftmost location as the vector endpoint. Finger vector 512 can be formed between the leftmost touch location and the adjacent touch location (ring finger location 504) with the leftmost touch location as the vector endpoint. Finger vector 513 can be formed between the leftmost touch location and the next touch location (middle finger location 503) with the leftmost touch location as the vector endpoint. Finger vector 514 can be formed between the leftmost touch location and the next touch location (index finger location 502) with the leftmost touch location as the vector endpoint. In this example, the gesture is made by a right hand. A similar left-handed gesture has the touch locations reversed from left to right with a similar concave orientation.

Referring again to FIG. 4, cross products can be calculated between each finger vector and the base vector (415). The sum of the cross products can be calculated to indicate the orientation of the touch locations as follows (420). A determination can be made whether the sum is above a predetermined positive threshold (425). In some embodiments, the threshold can be set at +50 cm². If so, this can indicate that the orientation of the touch locations is positive (or convex) with respect to the pixel coordinates, indicating that the touch surface has not been repositioned, as in FIG. 5a.

If the sum is not above the positive threshold, a determination can be made whether the sum is below a predetermined negative threshold (430). In some embodiments, the threshold can be set at −50 cm². If so, this can indicate that the orientation of the touch locations is negative (or concave) with respect to the pixel coordinates, indicating that the touch surface has been repositioned by 180°, as in FIG. 5b. If the touch surface has been repositioned, the pixel coordinates can be rotated by 180° (435). For example, the pixel coordinate (0, 0) in the upper left corner of the touch surface can become the pixel coordinate (xn, ym) in the lower right corner of the touch surface and vice versa.

If the sum is not below the negative threshold, the orientation is indeterminate and the pixel coordinates remain unchanged.

After the pixel coordinates are either maintained or changed, the touch surface can be available for other touches and/or gestures by the user depending on the needs of the touch surface applications.

It is to be understood that the method of FIG. 4 is not limited to that illustrated here, but can include additional and/or other logic for detecting an orientation of a gesture made on a touch surface that can be utilized to determine a repositioning of the touch surface.

For example, in some embodiments, if the fingers touching the touch surface move more than a certain distance, this can be an indication that the fingers are not gesturing to determine a repositioning of the touch surface. In some embodiments, the distance can be set at 2 cm. Accordingly, the method of FIG. 4 can abort without further processing.

In other embodiments, if the fingers tap on and then lift off the touch surface within a certain time, this can be an indication that the fingers are gesturing to determine a repositioning of the touch surface. In some embodiments, the tap-lift time can be set at 0.5 s. Accordingly, the method of FIG. 4 can execute.

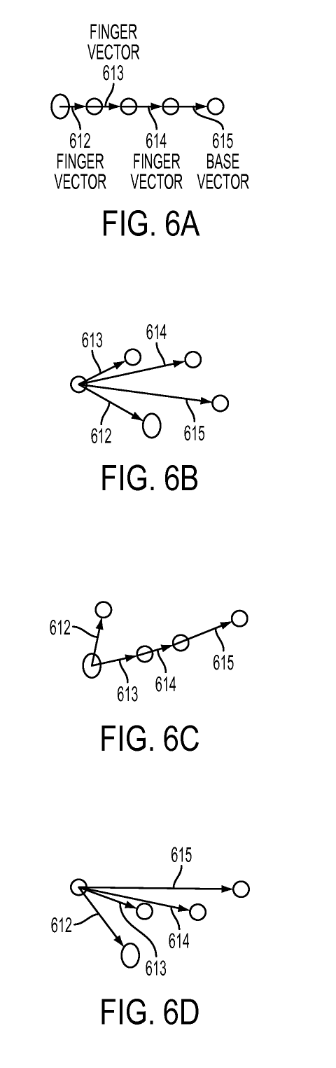

Some gestures can be ambiguous such that touch surface repositioning using the method of FIG. 4 can be difficult. The gesture illustrated in FIG. 3f is an example of this ambiguity. Since the touch locations are horizontally aligned, the determined base and finger vectors can also be horizontally aligned as illustrated in FIG. 6a. As a result, the calculated cross products are zero and their sum is zero. Because a sum of zero is likely less than the predetermined positive threshold and greater than the predetermined negative threshold such that the orientation is indeterminate, the method of FIG. 4 can abort without further processing.

Another example of an ambiguous gesture is illustrated in FIG. 3g. Since the index finger (rather than the thumb) is at the leftmost touch location, the determined base and finger vectors can be formed with the index finger touch location as the vector endpoints as illustrated in FIG. 6b. As a result, some calculated cross products are positive and others are negative. In the example of FIG. 6b, the cross products of finger vector 613 to base vector 615 and finger vector 614 to base vector 615 are positive, while the cross product of finger vector 612 to base vector 615 is negative. This can result in an erroneous lesser sum of the cross products, which could fall between the positive and negative thresholds such that the orientation is indeterminate and the pixel coordinates remain unchanged. To address this gesture ambiguity, the method of FIG. 4 can include additional logic. For example, after the cross products are calculated, a determination can be made as to whether all of the cross products are either positive or negative. If not, the method of FIG. 4 can abort without further processing.

Alternatively, to address the gesture ambiguity of FIG. 3g, the method of FIG. 4 can include additional logic to re-choose the base vector to include the thumb touch location, rather than the index finger touch location, as intended. Generally, the thumb touch location can have the highest eccentricity among the touch locations by virtue of the thumb touching more of the touch surface than other fingers during a gesture. Accordingly, after the base vector has been determined in the method of FIG. 4, the touch location having the highest eccentricity can be identified using any known suitable technique. If the identified touch location is not part of the base vector, the base vector can be re-chosen to replace either the leftmost or rightmost touch location with the identified thumb touch location. The resulting base vector can be formed between the identified touch location (i.e., the thumb touch location) and the unreplaced base vector touch location (i.e., the pinkie touch location). The method of FIG. 4 can then proceed with determining the finger vectors between the identified touch location and the remaining touch locations, where the identified touch location can be the endpoint of the finger vectors.

Alternatively, to address the gesture ambiguity of FIG. 3g, the method of FIG. 4 can include additional logic to weight the index finger selection for the base vector less, thereby reducing the likelihood of the pixel coordinates being changed erroneously. To do so, after the cross products are calculated in the method of FIG. 4, the higher eccentricity touch location among the base vector touch locations can be determined using any known suitable technique. Generally, the index finger touch location of the base vector can have a higher eccentricity than the pinkie finger touch location of the base vector because the index fingertip's larger size produces a larger touch location on a touch image. The highest eccentricity touch location among the remaining touch locations can be also determined using any known suitable technique. As described above, the thumb touch location can have the highest eccentricity. A ratio can be computed between the determined higher eccentricity touch location of the base vector and the determined eccentricity touch location of the remaining touch locations. The ratio can be applied as a weight to each of the calculated cross products, thereby reducing the sum of the cross products. As a result, the sum can be less than the predetermined positive threshold and greater than the predetermined negative threshold, such that the orientation is indeterminate and the pixel coordinates remain unchanged.

Another example of an ambiguous gesture is illustrated in FIG. 3h. Since the middle and ring fingers are bent, their finger vectors can be close to or aligned with the base vector as illustrated in FIG. 6c. As a result, the magnitudes of their finger vectors 613, 614 can be small, compared to the magnitude of the finger vector 612 for the index finger. To address this gesture ambiguity, the method of FIG. 4 can include additional logic to abort upon identification of this gesture. To do so, after the base and finger vectors are determined in the method of FIG. 4, the magnitudes of the finger vectors can be calculated according to any known suitable technique and ranked from largest to smallest. A first ratio between the largest and the next largest magnitudes can be computed. A second ratio between the next largest and the smallest magnitudes can also be computed. If the first ratio is small and the second ratio is large, the gesture can be identified as that of FIG. 3h or a similar ambiguous gesture. Accordingly, the method of FIG. 4 can be aborted without further processing.

Another example of an ambiguous gesture is illustrated in FIG. 3i. This gesture is similar to that of FIG. 3h with the exception of the thumb being tucked beneath the fingers. Because the thumb is tucked, the index finger touch location can be the leftmost location that forms the base vector as shown in FIG. 6d. As described previously, the base vector can be re-chosen to include the thumb touch location. This can result in the middle and ring finger vectors being close to or aligned with the re-chosen base vector. For this reason, as described above with respect to the finger vectors' magnitude rankings, the method of FIG. 4 can be aborted without further processing.

Alternatively, to address the gesture ambiguity of FIG. 3i, as described previously, the selection of the index finger as part of the base vector can be weighted less, reducing the likelihood of the pixel coordinates being erroneously changed.

It is to be understood that alternative and/or additional logic can be applied to the method of FIG. 4 to address ambiguous and/or other gestures.

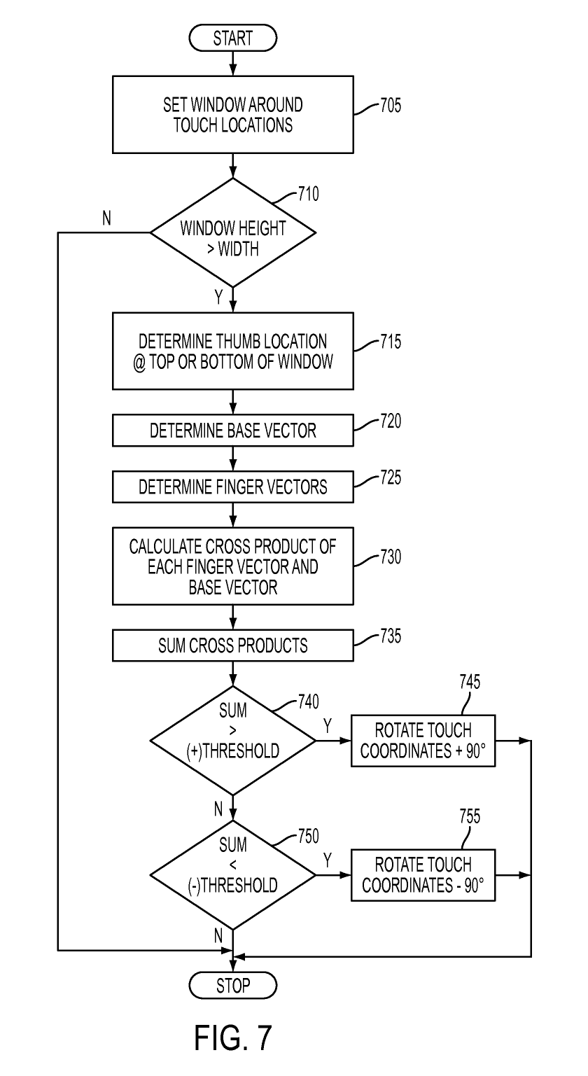

FIG. 7 illustrates an exemplary method of detecting an orientation of a gesture made on a touch surface to determine a ±90° repositioning of the touch surface according to various embodiments. In the example of FIG. 7, a touch image of a gesture made on a touch surface can be captured and touch locations in the touch image identified. A window can be set around the touch locations in a touch image of a gesture made on a touch surface (705).

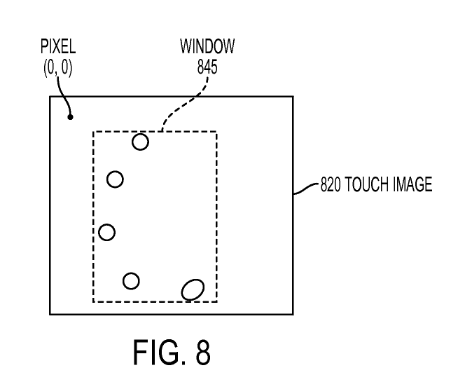

FIG. 8 illustrates an exemplary window around the touch locations in a touch image that can be used to determine a repositioning of the touch surface. Here, touch image 820 includes a pixel coordinate system in which pixel coordinate (0, 0) is in the upper left corner of the image. The image 820 shows window 845 around the touch locations made by a gesture on the touch surface. The user has rotated the touch surface +90° and is touching the surface with the hand in a vertical position. However, because the pixel coordinates have not been changed with the touch surface repositioning, the touch image 820 shows the hand touching the surface in a horizontal position.

Referring again to FIG. 7, a determination can be made whether the window height is greater than the window width (710). If so, as in FIG. 8, this can be an indication that the touch surface has been rotated by ±90°. Otherwise, the method can stop.

A determination can be made whether the thumb touch location is at the top or the bottom of the window so that the thumb location can be designated for vector endpoints (715). The determination can be made using any known suitable technique. A base vector can be determined between the determined thumb touch location and the touch location (i.e., the pinkie touch location) at the opposite end of the window (720). If the thumb touch location is at the top of the window, the base vector can be formed with the bottommost touch location in the window. Conversely, if the thumb touch location is at the bottom of the window, the base vector can be formed with the topmost touch location in the window. Finger vectors can be determined between the determined thumb location and the remaining touch locations (725).

Cross products can be calculated between each finger vector and the base vector (730). The sum of the cross products can be calculated to indicate the orientation of the touch locations as follows (735). A determination can be made as to whether the sum is above a predetermined positive threshold (740). In some embodiments, the threshold can be set at +50 cm². If so, this can indicate that the orientation of the touch locations is positive (or convex) with respect to the pixel coordinates, indicating that the touch surface has been repositioned by +90°. Accordingly, the pixel coordinates can be changed by +90° (745). For example, the pixel coordinate (0, 0) in the upper left corner of the touch surface can become the pixel coordinate (0, ym) in the upper right corner of the touch surface.

If the sum is not above the positive threshold, a determination can be made whether the sum is below a predetermined negative threshold (750). In some embodiments, the threshold can be set at −50 cm². If so, this can indicate that the orientation of the touch locations is negative (or concave) with respect to the pixel coordinates, indicating that the touch surface has been repositioned by −90°. Accordingly, the pixel coordinates can be changed by −90° (755). For example, the pixel coordinate (0, 0) in the upper left corner of the touch surface can become the pixel coordinate (xn, 0) in the lower left corner of the touch surface.

If the sum is not below the negative threshold, the orientation is indeterminate and the pixel coordinates remain unchanged.

After the pixel coordinates are either changed or maintained, the touch surface can be available for other touches and/or gestures by the user depending on the needs of the touch surface applications.

It is to be understood that the method of FIG. 7 is not limited to that illustrated here, but can include additional and/or other logic for detecting an orientation of a gesture made on a touch surface that can be utilized to determine a repositioning of the touch surface. For example, the method of FIG. 7 can include additional logic to address ambiguous and/or other gestures, as described previously.

Although the methods described herein use five-finger gestures, it is to be understood that any number of fingers can be used in gestures made on a touch surface to determine repositioning of the touch surface according to various embodiments. It is further to be understood that gestures to determine repositioning are not limited to those illustrated herein. For example, a gesture can be used to initially determine repositioning and then to trigger execution of an application.

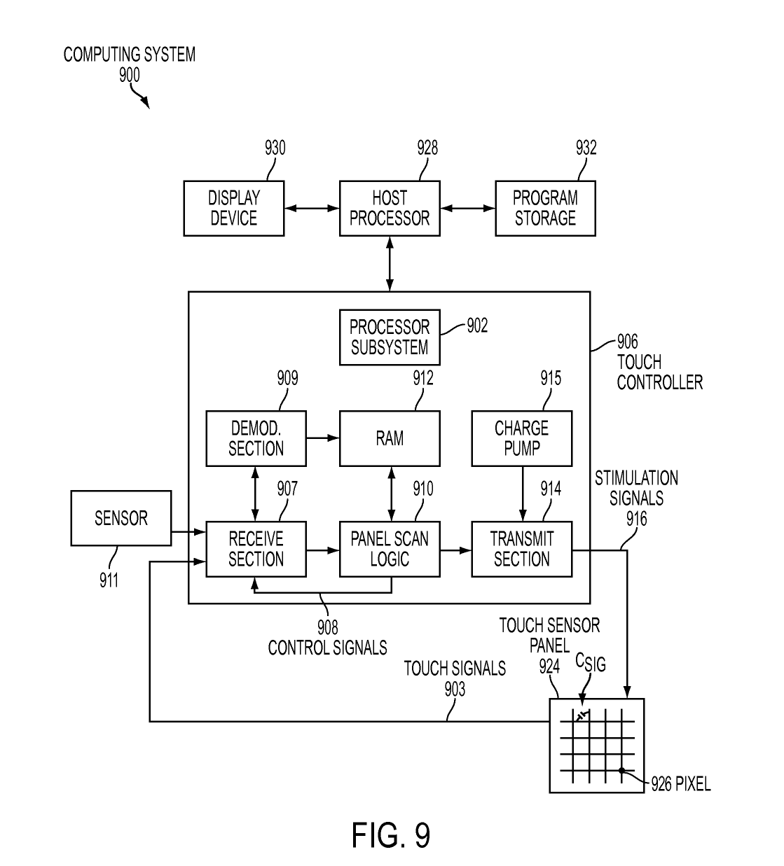

FIG. 9 illustrates an exemplary computing system 900 according to various embodiments described herein. In the example of FIG. 9, computing system 900 can include touch controller 906. The touch controller 906 can be a single application specific integrated circuit (ASIC) that can include one or more processor subsystems 902, which can include one or more main processors, such as ARM968 processors or other processors with similar functionality and capabilities. However, in other embodiments, the processor functionality can be implemented instead by dedicated logic, such as a state machine. The processor subsystems 902 can also include peripherals (not shown) such as random access memory (RAM) or other types of memory or storage, watchdog timers and the like. The touch controller 906 can also include receive section 907 for receiving signals, such as touch signals 903 of one or more sense channels (not shown), other signals from other sensors such as sensor 911, etc. The touch controller 906 can also include demodulation section 909 such as a multistage vector demodulation engine, panel scan logic 910, and transmit section 914 for transmitting stimulation signals 916 to touch sensor panel 924 to drive the panel. The panel scan logic 910 can access RAM 912, autonomously read data from the sense channels, and provide control for the sense channels. In addition, the panel scan logic 910 can control the transmit section 914 to generate the stimulation signals 916 at various frequencies and phases that can be selectively applied to rows of the touch sensor panel 924.

The touch controller 906 can also include charge pump 915, which can be used to generate the supply voltage for the transmit section 914. The stimulation signals 916 can have amplitudes higher than the maximum voltage by cascading two charge store devices, e.g., capacitors, together to form the charge pump 915. Therefore, the stimulus voltage can be higher (e.g., 6V) than the voltage level a single capacitor can handle (e.g., 3.6 V). Although FIG. 9 shows the charge pump 915 separate from the transmit section 914, the charge pump can be part of the transmit section.

Touch sensor panel 924 can include a repositionable touch surface having a capacitive sensing medium with row traces (e.g., drive lines) and column traces (e.g., sense lines), although other sensing media and other physical configurations can also be used. The row and column traces can be formed from a substantially transparent conductive medium such as Indium Tin Oxide (ITO) or Antimony Tin Oxide (ATO), although other transparent and non-transparent materials such as copper can also be used. The traces can also be formed from thin non-transparent materials that can be substantially transparent to the human eye. In some embodiments, the row and column traces can be perpendicular to each other, although in other embodiments other non-Cartesian orientations are possible. For example, in a polar coordinate system, the sense lines can be concentric circles and the drive lines can be radially extending lines (or vice versa). It should be understood, therefore, that the terms “row” and “column” as used herein are intended to encompass not only orthogonal grids, but the intersecting or adjacent traces of other geometric configurations having first and second dimensions (e.g. the concentric and radial lines of a polar-coordinate arrangement). The rows and columns can be formed on, for example, a single side of a substantially transparent substrate separated by a substantially transparent dielectric material, on opposite sides of the substrate, on two separate substrates separated by the dielectric material, etc.

Where the traces pass above and below (intersect) or are adjacent to each other (but do not make direct electrical contact with each other), the traces can essentially form two electrodes (although more than two traces can intersect as well). Each intersection or adjacency of row and column traces can represent a capacitive sensing node and can be viewed as picture element (pixel) 926, which can be particularly useful when the touch sensor panel 924 is viewed as capturing an “image” of touch. (In other words, after the touch controller 906 has determined whether a touch event has been detected at each touch sensor in the touch sensor panel, the pattern of touch sensors in the multi-touch panel at which a touch event occurred can be viewed as an “image” of touch (e.g. a pattern of fingers touching the panel).) The capacitance between row and column electrodes can appear as a stray capacitance Cstray when the given row is held at direct current (DC) voltage levels and as a mutual signal capacitance Csig when the given row is stimulated with an alternating current (AC) signal. The presence of a finger or other object near or on the touch sensor panel can be detected by measuring changes to a signal charge Qsig present at the pixels being touched, which can be a function of Csig. The signal change Qsig can also be a function of a capacitance Cbody of the finger or other object to ground.

Computing system 900 can also include host processor 928 for receiving outputs from the processor subsystems 902 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. The host processor 928 can also perform additional functions that may not be related to panel processing, and can be coupled to program storage 932 and display device 930 such as an LCD display for providing a UI to a user of the device. In some embodiments, the host processor 928 can be a separate component from the touch controller 906, as shown. In other embodiments, the host processor 928 can be included as part of the touch controller 906. In still other embodiments, the functions of the host processor 928 can be performed by the processor subsystem 902 and/or distributed among other components of the touch controller 906. The display device 930 together with the touch sensor panel 924, when located partially or entirely under the touch sensor panel or when integrated with the touch sensor panel, can form a touch sensitive device such as a touch screen.

Detection of a gesture orientation for determining a repositioning of a touch surface, such as the touch sensor panel 924, can be performed by the processor in subsystem 902, the host processor 928, dedicated logic such as a state machine, or any combination thereof according to various embodiments.

Note that one or more of the functions described above can be performed, for example, by firmware stored in memory (e.g., one of the peripherals) and executed by the processor subsystem 902, or stored in the program storage 932 and executed by the host processor 928. The firmware can also be stored and/or transported within any computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer readable storage medium” can be any medium that can contain or store the program for use by or in connection with the instruction execution system, apparatus, or device. The computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

It is to be understood that the touch sensor panel is not limited to touch, as described in FIG. 9, but can be a proximity panel or any other panel according to various embodiments. In addition, the touch sensor panel described herein can be a multi-touch sensor panel.

It is further to be understood that the computing system is not limited to the components and configuration of FIG. 9, but can include other and/or additional components in various configurations capable of detecting gesture orientation for repositionable touch surfaces according to various embodiments.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A method comprising:
detecting an orientation of a gesture made on a touch surface; and
determining a repositioning of the touch surface based on the detected gesture orientation.

2. The method of claim 1, wherein detecting the orientation of the gesture comprises:
capturing a touch image of a gesture made on a touch surface;
identifying touch locations of the gesture in the touch image;
determining a base vector between a leftmost and a rightmost of the touch locations;
determining finger vectors between the leftmost or rightmost touch location and the remaining touch locations;
calculating cross products between the finger vectors and the base vector; and
summing the cross products, the sum being indicative of the gesture orientation.

3. The method of claim 2, wherein the touch locations correspond to touches on the touch surface by a thumb, an index finger, a middle finger, a ring finger, and a pinkie.

4. The method of claim 2, wherein the leftmost and rightmost touch locations correspond to touches by a thumb and a pinkie.

5. The method of claim 1, wherein determining the repositioning of the touch surface comprises:
if a sum of cross products of vectors formed between fingers making the gesture is positive, determining that there has been no repositioning of the touch surface; and
if the sum of the cross products is negative, determining that there has been a repositioning of the touch surface by about 180°.

6. The method of claim 5, wherein the sum of the cross products is positive if the sum is greater than a predetermined positive threshold and the sum of the cross products is negative is the sum is less than a predetermined negative threshold.

7. A touch sensitive device comprising:
a touch surface having multiple pixel locations for detecting a gesture; and
a processor in communication with the touch surface and configured to
identify an orientation of the detected gesture,
determine whether the touch surface is repositioned based on the identified orientation, and
reconfigure coordinates of the pixel locations based on the determination.

8. The device of claim 7, wherein identifying the orientation of the detected gesture comprises:
identifying touch locations of the gesture on the touch surface;
determining a base vector between a leftmost and a rightmost of the touch locations;
if neither the leftmost nor rightmost touch location corresponds to a thumb touch, replacing the determined base vector with another base vector between the touch location corresponding to the thumb touch and either the leftmost or rightmost touch location; and
utilizing either the determined base vector or the other base vector to identify the gesture orientation.

9. The device of claim 7, wherein identifying the orientation of the detected gesture comprises:
identifying touch locations of the gesture on the touch surface;
determining a base vector between a leftmost and a rightmost of the touch locations;
determining finger vectors between the leftmost or rightmost touch location and the remaining touch locations;
selecting a larger eccentricity of the leftmost and the rightmost touch locations;
selecting a largest eccentricity among the remaining touch locations;
calculating a ratio of the selected larger eccentricity to the selected largest eccentricity;
calculating cross products between the base vector and the finger vectors;
applying the ratio as a weight to the calculated cross products; and
utilizing the weighted cross products to identify the gesture orientation.

10. The device of claim 7, wherein identifying the orientation of the detected gesture comprises:
identifying touch locations of the gesture on the touch surface;
determining a base vector between a leftmost and a rightmost of the touch locations;
determining finger vectors between the leftmost or the rightmost touch location and the remaining touch locations;
computing magnitudes of the finger vectors;
calculating a first ratio between the two largest magnitudes;
calculating a second ratio between the two smallest magnitudes;
comparing the first and second ratios; and
if the second ratio is substantially larger than the first ratio, aborting execution by the processor.

11. The device of claim 7, wherein identifying the orientation of the detected gesture comprises:
identifying touch locations of the gesture on the touch surface;
determining a base vector between a leftmost and a rightmost of the touch locations;
determining finger vectors between the leftmost or the rightmost touch location and the remaining touch locations; and
if the finger vectors are aligned with the base vector, aborting execution by the processor.

12. The device of claim 7, wherein identifying the orientation of the detected gesture comprises:
identifying touch locations of the gesture on the touch surface;
determining a base vector between a leftmost and a rightmost of the touch locations;
determining finger vectors between the leftmost or the rightmost touch location and the remaining touch locations;
calculating cross products between the base vector and the finger vectors; and
if all of the cross products do not have the same sign, aborting execution by the processor.

13. The device of claim 7, wherein determining whether the touch surface is repositioned comprises:
determining that the touch surface is not repositioned if the orientation indicates a convexity of the gesture; and
determining that the touch surface is repositioned if the orientation indicates a concavity of the gesture.

14. The device of claim 7, wherein reconfiguring the coordinates of the pixel locations comprises changing the coordinates of the pixel locations to correspond to approximately a 180° repositioning of the touch surface.

15. A method comprising:
setting a window around touch locations in a touch image of a gesture made on a touch surface;
detecting an orientation of the gesture according to the touch locations in the window; and
determining a repositioning of the touch surface based on the detected orientation.

16. The method of claim 15, wherein detecting the orientation of the gesture comprises:
comparing a length of the window to a width of the window; and
if the window length is greater than the window width,
determining which of a topmost or a bottommost of the touch locations corresponds to a thumb touch,
determining a base vector between the topmost and bottommost touch locations,
determining finger vectors between the determined thumb touch location and the remaining touch locations,
calculating cross products between the finger vectors and the base vector, and
summing the calculated cross products, the sum being indicative of the gesture orientation.

17. The method of claim 16, wherein the topmost and the bottommost touch locations correspond to touches by a thumb and a pinkie on the touch surface.

18. The method of claim 15, wherein determining the repositioning of the touch surface comprises:
if a sum of cross products of vectors formed between the fingers making the gesture is greater than a predetermined positive threshold, determining that there has been a repositioning of the touch surface by about +90°; and
if the sum of the cross products is less than a predetermined negative threshold, determining that there has been a repositioning of the touch surface by about −90°.

19. A touch sensitive device comprising:
a touch surface having multiple pixel locations for detecting a gesture; and
a processor in communication with the touch surface and configured to
set a window around a touch image of the detected gesture,
determine whether the touch surface is repositioned based on an orientation of the gesture in the window, and
reconfigure coordinates of the pixel locations based on the determination.

20. The device of claim 19, wherein the processor is configured to execute upon detection of a tap gesture on the touch surface.

21. The device of claim 19, wherein the processor is configured not to execute upon detection of a gesture movement exceeding a predetermined distance on the touch surface.

22. The device of claim 19, wherein the touch surface is repositionable by about ±90°.

23. A repositionable touch surface comprising multiple pixel locations for changing coordinates in response to a repositioning of the touch surface, the repositioning being determined based on a characteristic of a gesture made on the touch surface.

24. The repositionable touch surface of claim 23, wherein the characteristic is an orientation of a five-finger gesture.

25. The repositionable touch surface of claim 23 incorporated into a computing system.
